(19) United States
(12) Patent Application Publication
(10) Pub. No.: US 2016/0012646 A1
(43) Pub. Date: Jan. 14, 2016

(54) SYSTEMS AND METHODS FOR CONSTRUCTING A THREE DIMENSIONAL (3D) COLOR REPRESENTATION OF AN OBJECT

(71) Applicant: PERFETCH, LLC, Wilmington, DE (US)

(72) Inventors: Minyang Huang, Andover, MA (US); Fan Wu, Malden, MA (US); Weitao Wang, Malden, MA (US)

(21) Appl. No.: 14/328,293

(22) Filed: Jul. 10, 2014

(51) Int. Cl. G06T 19/20; G06T 17/00; G06T 5/00; H04L 29/08

(52) U.S. Cl. CPC G06T 19/20; H04L 67/10; G06T 17/00; G06T 5/005; G06T 2219/2012; G06T 2207/10028

(57) ABSTRACT

In some aspects, the disclosure is directed methods and systems for constructing a three dimensional (3D) color representation of an object. A first sensor may acquire a first depth image and a first color image of an object from a first angle relative to the object. A second sensor may acquire a second depth image and a second color image of the object from a second angle relative to the object. A processor may map color information from pixels of the first color image to pixels of the first depth image to form a first 3D distribution of colored points representing a first surface portion of the object. The processor may map color information from pixels of the second color image to pixels of the second depth image to form a second 3D distribution of colored points representing a second surface portion of the object. The processor may match, based on 3D structure, a portion of the first 3D distribution of colored points, to a portion of the second 3D distribution of colored points.

### FIELD OF THE DISCLOSURE

This disclosure generally relates to systems and methods for imaging an object. In particular, this disclosure relates to systems and methods for generating a three dimensional (3D) representation of an object.

### BACKGROUND OF THE DISCLOSURE

Generally, people across the world are increasingly more aware or concerned about their health. Some may try to improve their overall health via exercise and/or diet. Certain people may try to lose weight in order to avoid risks associated with obesity, such as heart disease, high blood pressure, diabetes, etc. According to the National Institute of Health (NIH), up to a third of Americans are already considered clinically overweight. Moreover, there is no sign that the number of overweight people would go down. Yet others may try to improve their physique and/or posture. Regardless of the ways one may pursue to change or improve one's body, it is helpful to track or monitor the changes. For example, one may need a way to monitor or track the effects of a workout regimen over time. There are certain tools and mobile applications to help people track their progress. For instance, wearable devices such as Nike's fuel band may track the number of calories consumed or expended while wearing the device. Calories, of course, can be a metric to track the progress of workouts. However, few people understand or know how to associate such metrics with something more tangible or reflective of their bodies. For example, the more changes that people can physically observe as occurring to their bodies, the more motivation they may be. One cannot directly visualize changes to peoples' bodies through wearable devices for example, as a result of ongoing exercise. An alternative may be to use measuring devices such as a measuring tape. A measuring tape, for example, can demonstrate how many inches you have lost. However, it is not the most convenient mode and often requires a second person to take various measurements off one's body, and many persons are uncomfortable doing this for various reasons.

### BRIEF SUMMARY OF THE DISCLOSURE

Described herein are systems and methods for generating a three dimensional (3D) representation of an object. Illustrative applications for the present systems and methods may include, but not limited to 3D color scanning of a person or object associated with medical treatment, health monitoring, physique and/or posture improvement and/or correction, fitting and/or design of garment or accessories, 3D modelling and 3D printing. Certain aspects of this disclosure are directed to a scanning booth or system for acquiring depth and color values from a person or an object, using a plurality of sensors spatially configured around the person or object. Each sensor may acquire depth and color information from a surface portion of the person or object. The configuration of sensors may be optimized or configured for imaging a human body or particular types of objects, e.g., by setting or adjusting a sensor's field of view, angle, orientation, and/or spatial arrangement with respect to one or more other sensors. The configuration of sensors can provide for rapid scanning and 3D color image generation, for example within five seconds in certain embodiments.

Accurate co-registration of the color and depth values , e.g., during acquisition and processing of such information, can provide realistic generation of color images of surface portions of the person or object. A processor can locate and/or match overlapping 3D regions of the plurality of surface portions, for stitching into a 3D color model of the person or object. The processor may generate data for portions of the 3D model that may be missing, noisy or rejected. Certain embodiments of the present system and methods may provide analysis of the generated or fully-constructed 3D color model, for example, performing measurement of body parts, determining tissue composition or body mass index (BMI), classifying body types, and comparing or tracking changes over time or over multiple 3D images. Secure and/or encrypted storage of an image can ensure privacy of an individual that has been scanned.

In some aspects, the present disclosure pertains to a method for method for constructing a three dimensional (3D) color representation of an object. The method may include acquiring, by a first sensor, a first depth image and a first color image of an object from a first angle relative to the object. A second sensor may acquire a second depth image and a second color image of the object from a second angle relative to the object. A processor may map color information from pixels of the first color image to pixels of the first depth image to form a first 3D distribution of colored points representing a first surface portion of the object. The processor may map color information from pixels of the second color image to pixels of the second depth image to form a second 3D distribution of colored points representing a second surface portion of the object. The processor may match, based on 3D structure, a portion of the first 3D distribution of colored points, to a portion of the second 3D distribution of colored points.

In some embodiments, the first sensor acquires the first depth image, the first depth image comprising an array of depth values. The first sensor may acquire the first color image, the first color image having a resolution that is at least the same as that of the first depth image. The first sensor may acquire the first depth image, each pixel of the first depth image having a pixel value representing a spatial distance of the object relative to the first sensor. The first sensor may acquire the first depth image via a first depth sensor of the first sensor, and acquiring the first color image via a first color sensor of the first sensor.

In certain embodiments, the processor may minimize an alignment energy between the first 3D distribution of colored points and the second 3D distribution of colored points. The processor may align the first 3D distribution of colored points to the second 3D distribution of colored points based on the matching. The processor may form a 3D representation of a surface of the object by aligning between the first 3D distribution of colored points, the second 3D distribution of colored points, and at least one other 3D distribution of colored points. The processor may perform geometric partial differential equation (PDE) based filtering on the 3D representation to generate at least one point that is missing from the 3D representation. In some embodiments, the processor may calculate color information for the at least one point that is missing from the 3D representation.

In certain aspects, the present disclosure pertains to a system for constructing a three dimensional (3D) color representation of an object. The system may include a first sensor configured to acquire a first depth image and a first color image of an object from a first angle relative to the object. A second sensor may be configured to acquire a second depth image and a second color image of the object from a second angle relative to the object. A processor may be configured to map color information from pixels of the first color image to pixels of the first depth image to form a first 3D distribution of colored points representing a first surface portion of the object. The processor may be configured to map color information from pixels of the second color image to pixels of the second depth image to form a second 3D distribution of colored points representing a second surface portion of the object. The processor may be configured to match, based on 3D structure, a portion of the first 3D distribution of colored points, to a portion of the second 3D distribution of colored points.

In some embodiments, the first sensor is configured to acquire the first depth image, the first depth image comprising an array of depth values. The first sensor may be configured to acquire the first color image, the first color image having a resolution that is at least the same as that of the first depth image. The first sensor may be configured to acquire the first depth image, each pixel of the first depth image having a pixel value representing a spatial distance of the object relative to the first sensor. The first sensor may include a first depth sensor and a first color sensor.

In some embodiments, the processor is configured to minimize an alignment energy between the first 3D distribution of colored points and the second 3D distribution of colored points. The processor may be configured to align the first 3D distribution of colored points to the second 3D distribution of colored points based on the matching. The processor may be configured to form a 3D representation of a surface of the object by aligning between the first 3D distribution of colored points, the second 3D distribution of colored points, and at least one other 3D distribution of colored points. The processor may be configured to perform geometric partial differential equation (PDE) based filtering on the 3D representation to generate at least one point that is missing from the 3D representation. In certain embodiments, the processor is configured to calculate color information for the at least one point that is missing from the 3D representation.

The details of various embodiments of the invention are set forth in the accompanying drawings and the description below.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client machines in communication with remote machines;

FIGS. 1B and 1C are block diagrams depicting embodiments of computing devices useful in connection with the methods and systems described herein;

FIG. 2A is a block diagram depicting one embodiment of a system for constructing a 3D color representation of an object;

FIGS. 2B and 2C depict embodiments of process flows for generating a 3D color model of an object;

FIGS. 2D and 2E depict example embodiments of flow diagrams for a method for performing post-processing on a 3D color model;

FIG. 2F depicts an embodiment of a block diagram of a system for generating a 3D color image and performing parts or shape identification;

FIG. 2G depicts an illustrative embodiment of a flow diagram for performing parts or shape identification;

FIG. 2H depicts one illustrative embodiment of a flow diagram of operations performed by a measurement engine;

FIG. 21 depicts one example embodiment of operations performed by an image engine;

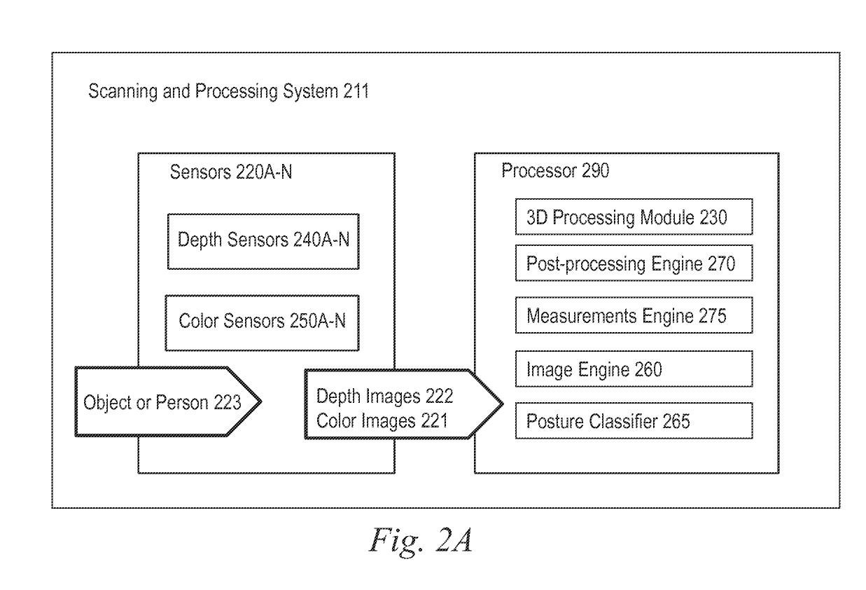

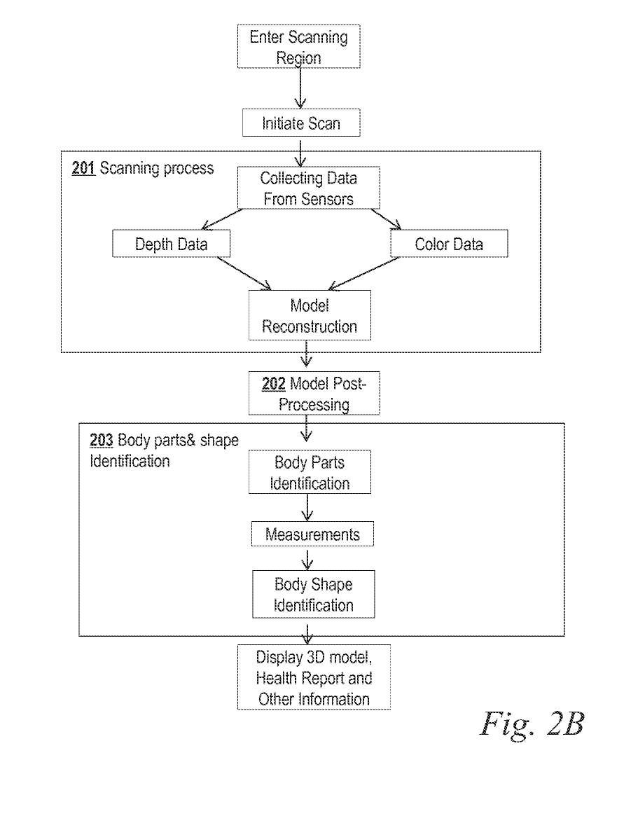

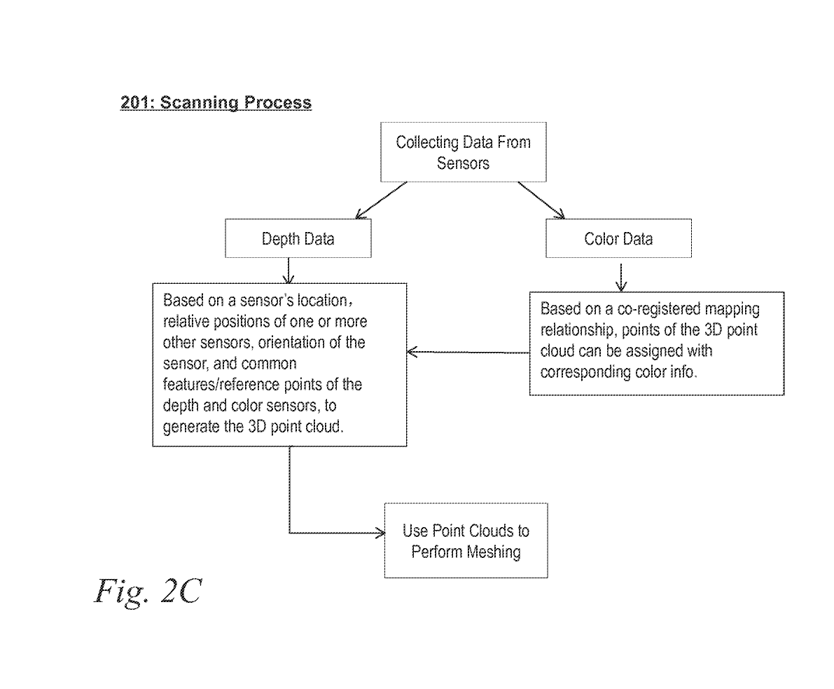

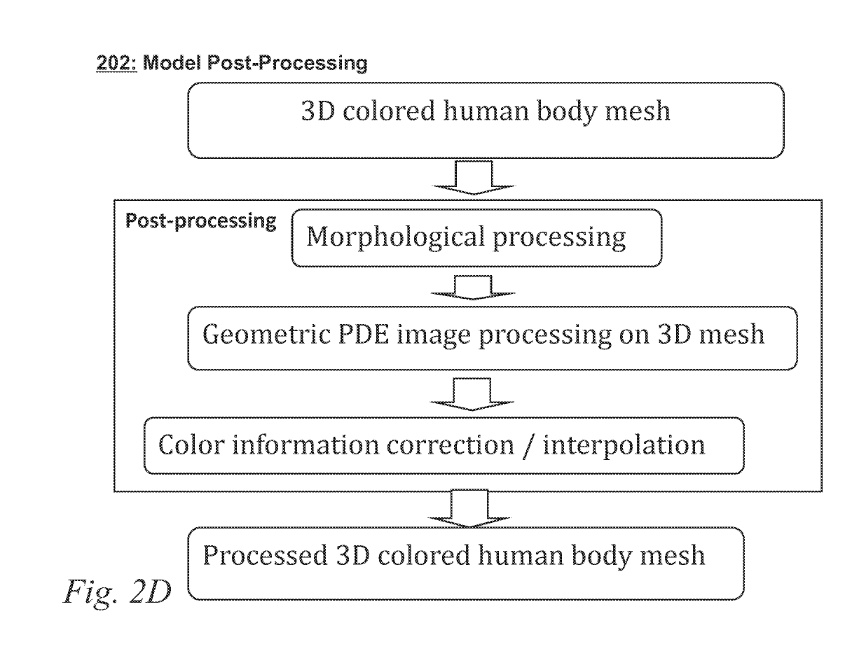

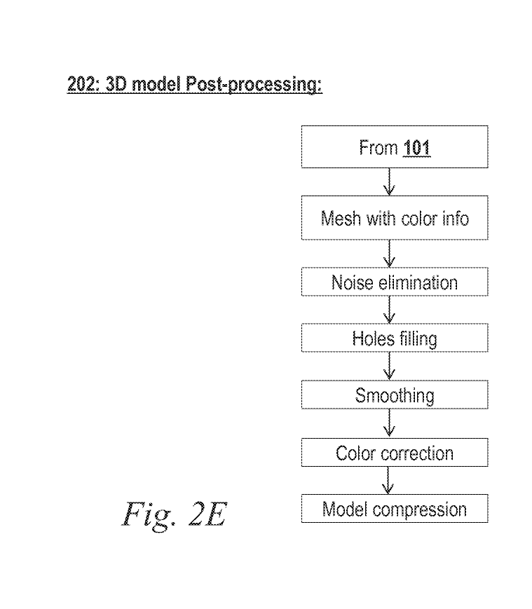

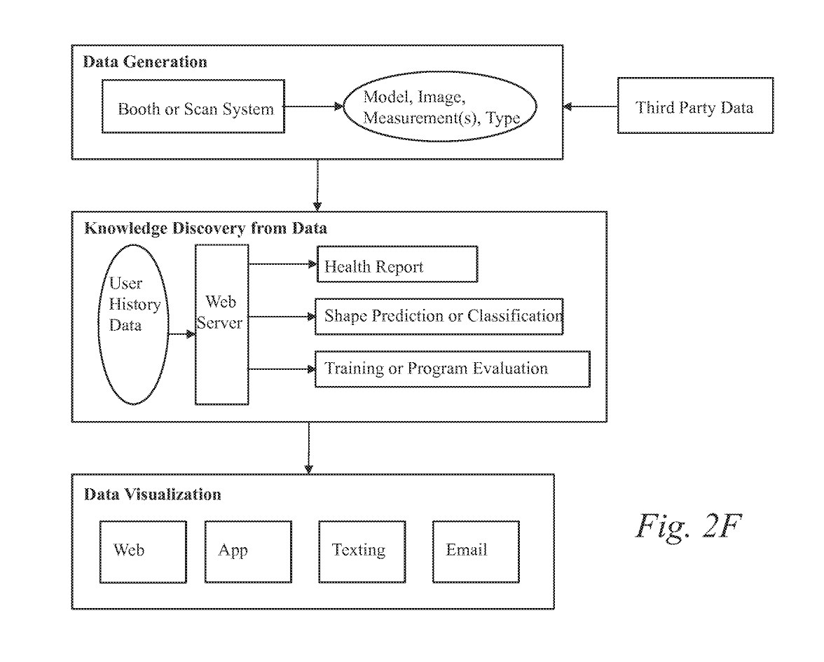

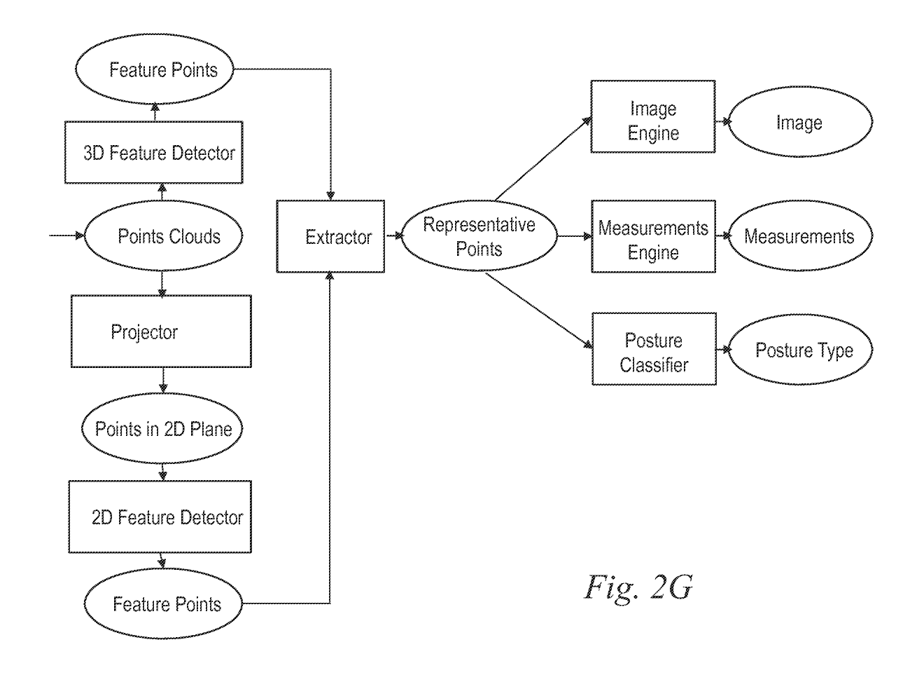

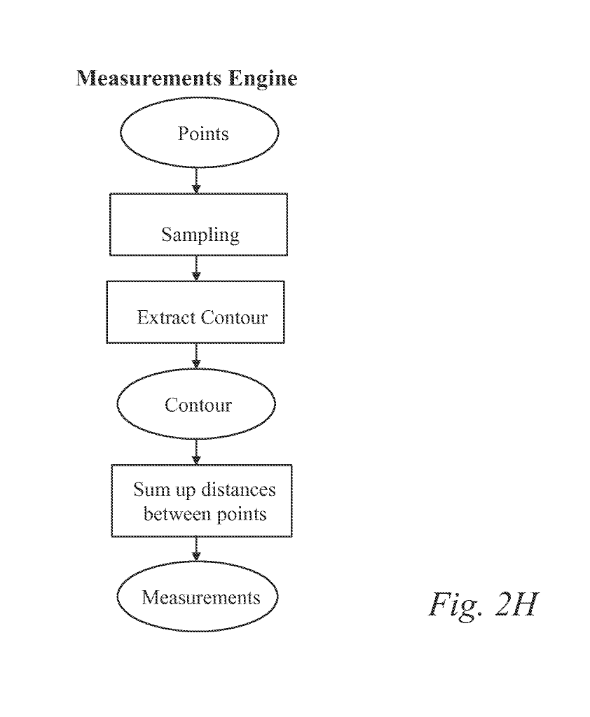

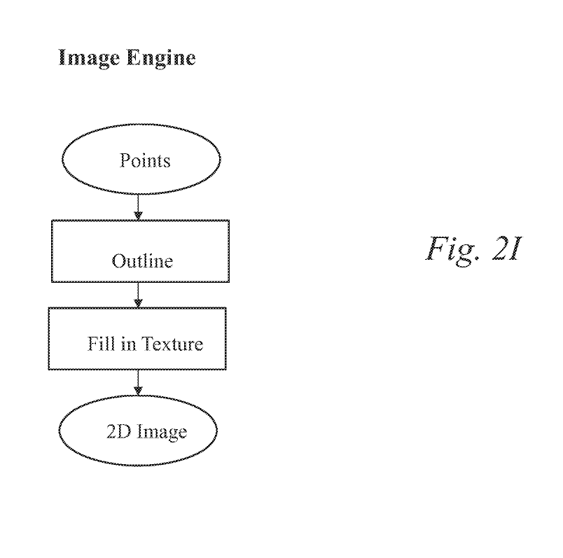

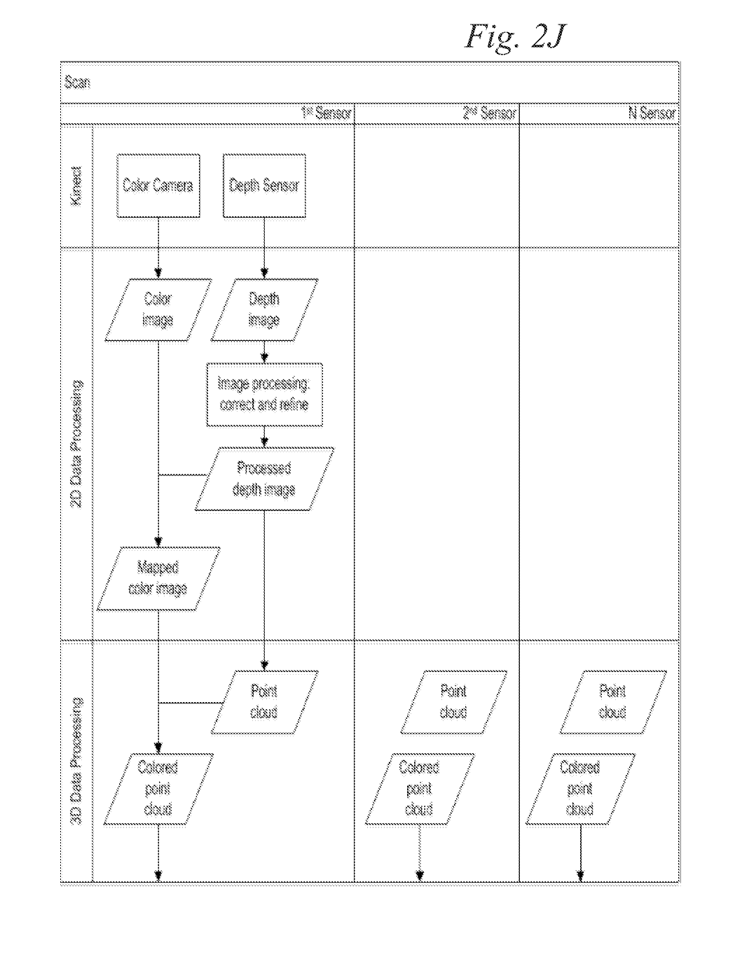

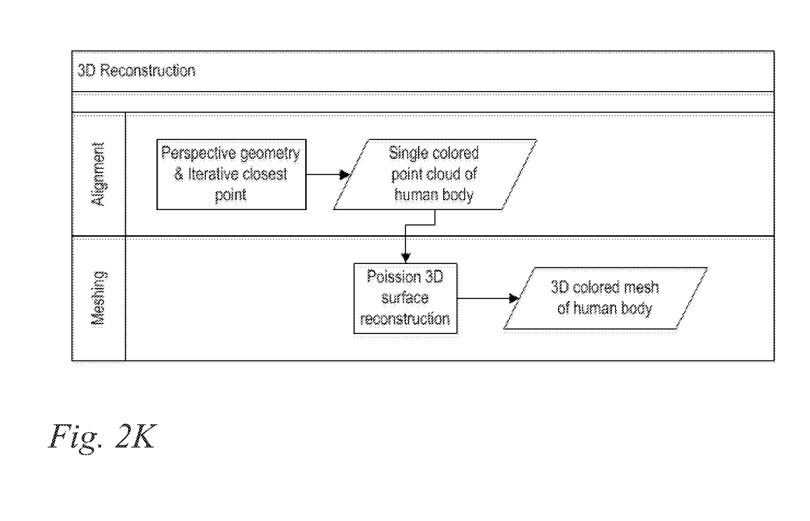

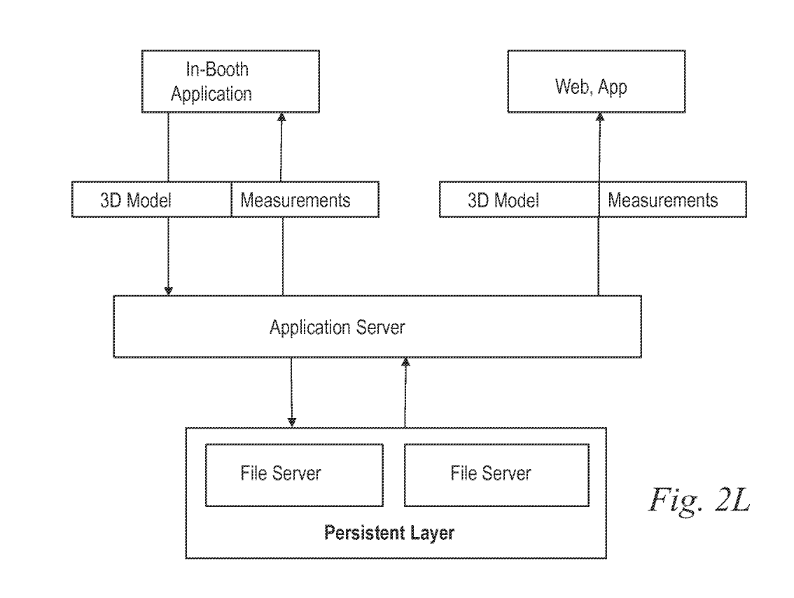

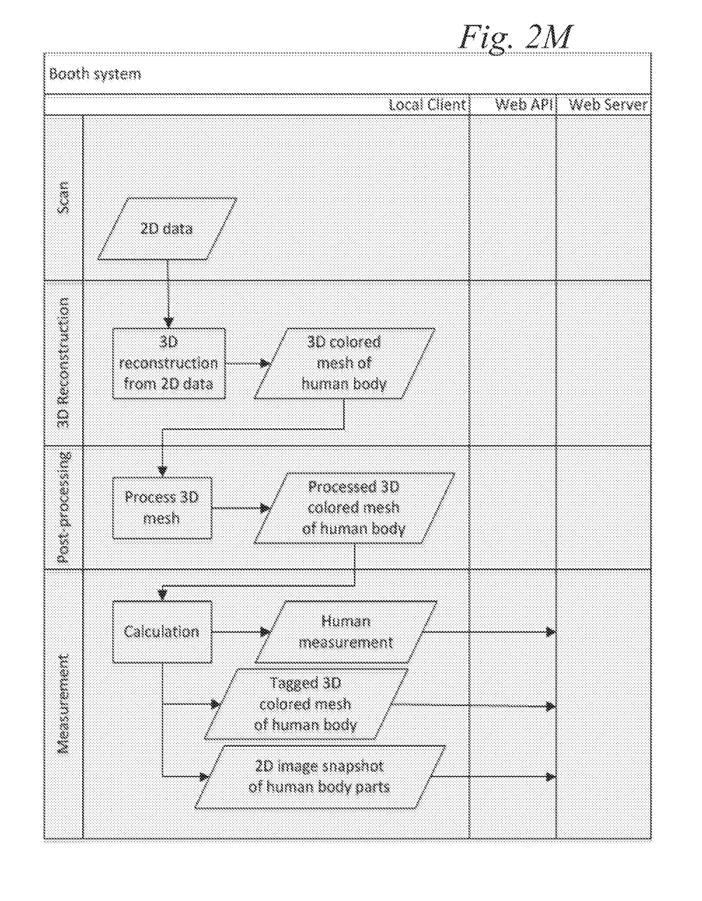

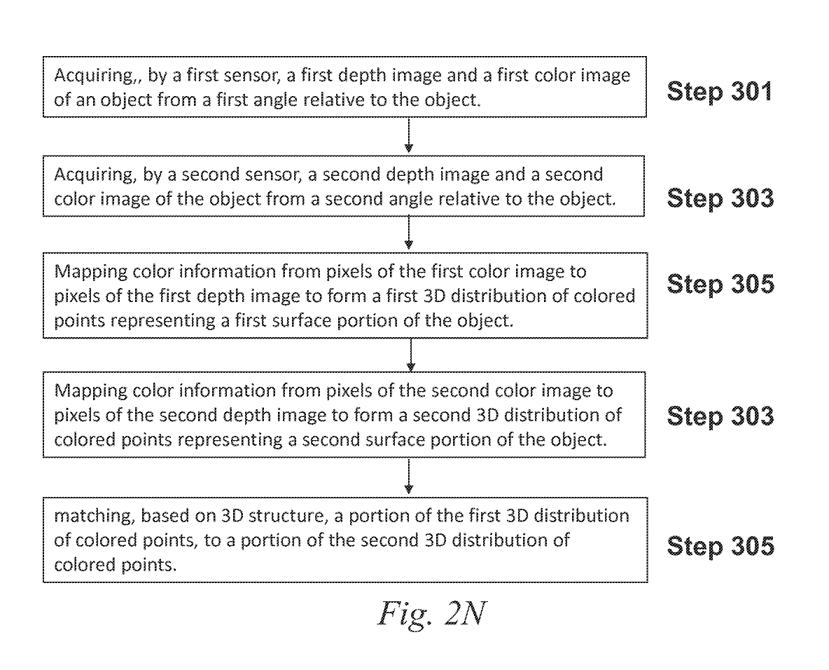

FIG. 2J depicts one illustrative embodiment of a flow diagram for generating a 3D color model of an object;

FIG. 2K depicts one embodiment of a flow diagram for generating point clouds and 3D model reconstruction;

FIG. 2L depicts one illustrative embodiment of a block diagram of a system for generating and accessing a 3D color image of an object;

FIG. 2M depicts one example embodiment of a flow diagram of a method for generating and processing a 3D color model of an object; and

FIG. 2N depicts one embodiment of a method for constructing a three dimensional (3D) color representation of an object.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein; and
Section B describes embodiments of systems and methods for constructing a three dimensional (3D) color representation of an object.

### A. Computing and Network Environment

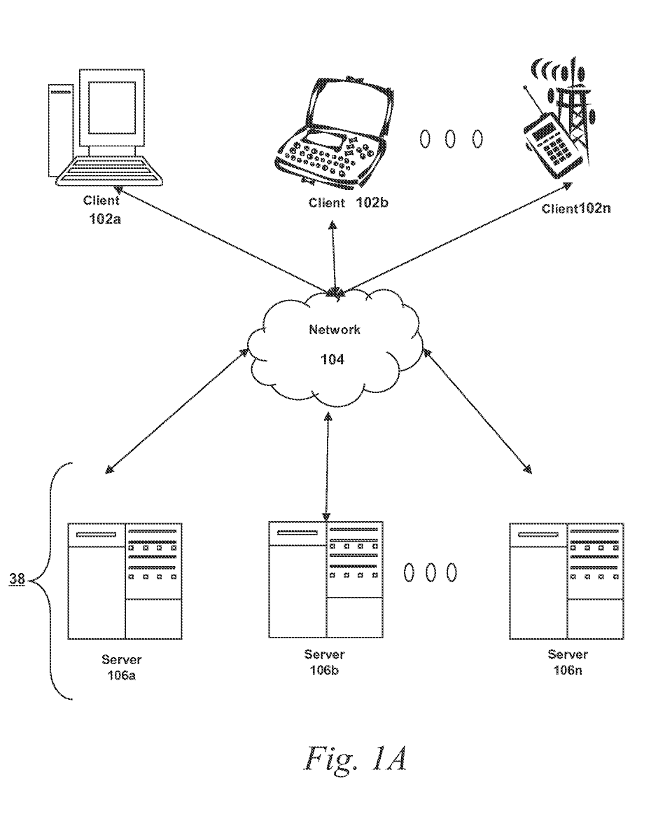

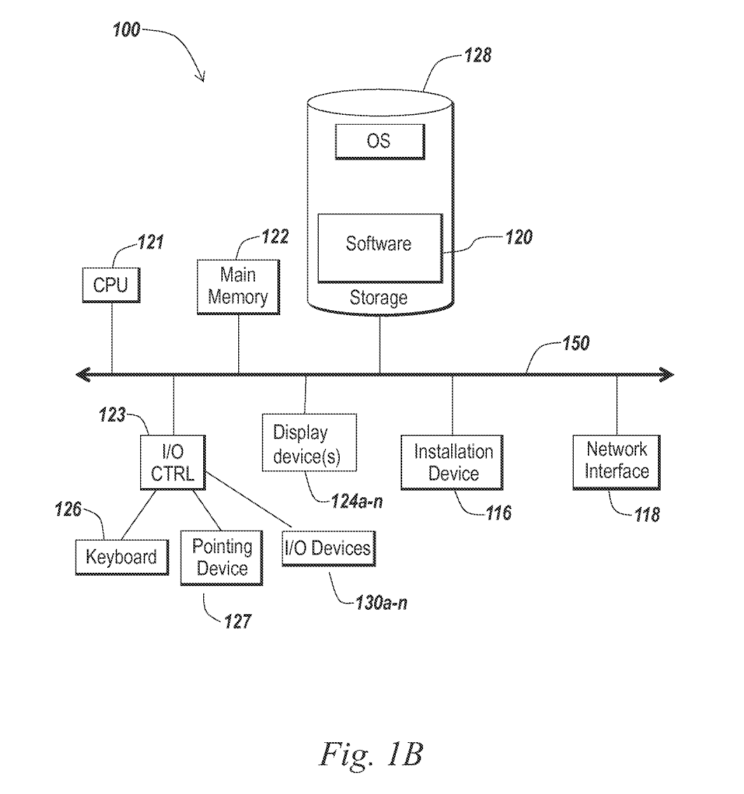

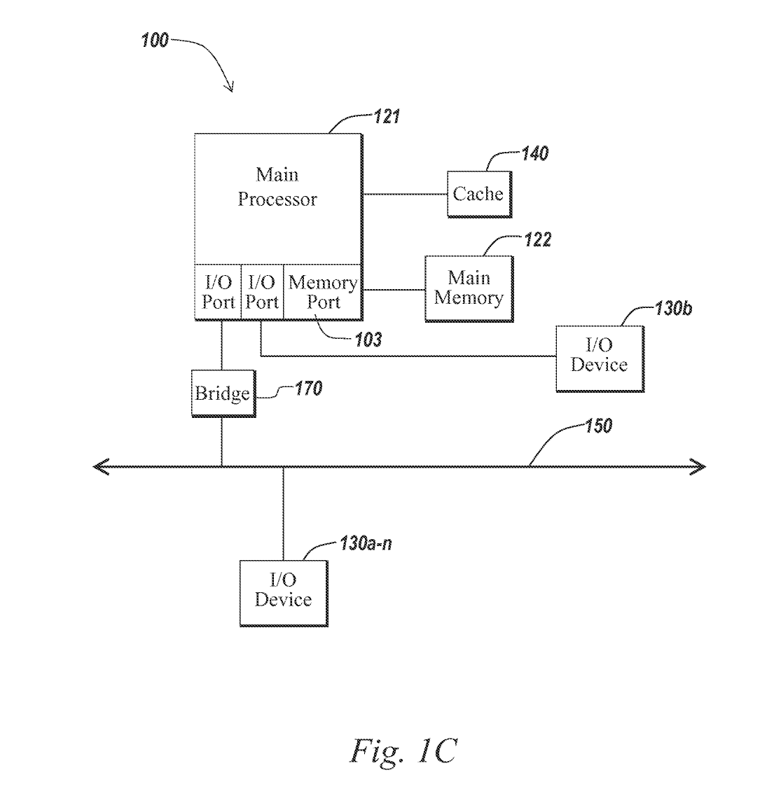

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 101a-101n (also generally referred to as local machine(s) 101, client(s) 101, client node(s) 101, client machine(s) 101, client computer(s) 101, client device(s) 101, endpoint(s) 101, or endpoint node(s) 101) in communication with one or more servers 106a-106n (also generally referred to as server(s) 106, node 106, or remote machine(s) 106) via one or more networks 104. In some embodiments, a client 101 has the capacity to function as both a client node seeking access to resources provided by a server and as a server providing access to hosted resources for other clients 101a-101n.

Although FIG. 1A shows a network 104 between the clients 101 and the servers 106, the clients 101 and the servers 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 101 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol(s) or standard(s) used to communicate among mobile devices, including AMPS, TDMA, CDMA, GSM, GPRS, UMTS, WiMAX, 3G or 4G. In some embodiments, different types of data may be transmitted via different protocols. In other embodiments, the same types of data may be transmitted via different protocols.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS, manufactured by Microsoft Corp. of Redmond, Washington), while one or more of the other servers 106 can operate on according to another type of operating system platform (e.g., Unix or Linux).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif.; the Xen hypervisor, an open source product whose development is overseen by Citrix Systems, Inc.; the Virtual Server or virtual PC hypervisors provided by Microsoft or others.

In order to manage a machine farm 38, at least one aspect of the performance of servers 106 in the machine farm 38 should be monitored. Typically, the load placed on each server 106 or the status of sessions running on each server 106 is monitored. In some embodiments, a centralized service may provide management for machine farm 38. The centralized service may gather and store information about a plurality of servers 106, respond to requests for access to resources hosted by servers 106, and enable the establishment of connections between client machines 101 and servers 106.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

In one embodiment, the server 106 provides the functionality of a web server. In another embodiment, the server 106a receives requests from the client 101, forwards the requests to a second server 106b and responds to the request by the client 101 with a response to the request from the server 106b. In still another embodiment, the server 106 acquires an enumeration of applications available to the client 101 and address information associated with a server 106′ hosting an application identified by the enumeration of applications. In yet another embodiment, the server 106 presents the response to the request to the client 101 using a web interface. In one embodiment, the client 101 communicates directly with the server 106 to access the identified application. In another embodiment, the client 101 receives output data, such as display data, generated by an execution of the identified application on the server 106.

The client 101 and server 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the client 101 or a server 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-101n, a keyboard 126 and a pointing device 127, such as a mouse. The storage device 128 may include, without limitation, an operating system and/or software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), Ferroelectric RAM (FRAM), NAND Flash, NOR Flash and Solid State Drives (SSD). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 may communicate directly with I/O device 130b, for example via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, dials, touch pads, and drawing tablets. Output devices include video displays, speakers, inkjet printers, laser printers, projectors and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, California.

Referring again to FIG. 1B, the computing device 100 may support any suitable installation device 116, such as a disk drive, a CD-ROM drive, a CD-R/RW drive, a DVD-ROM drive, a flash memory drive, tape drives of various formats, USB device, hard-drive or any other device suitable for installing software and programs. The computing device 100 can further include a storage device, such as one or more hard disk drives or redundant arrays of independent disks, for storing an operating system and other related software, and for storing application software programs such as any program or software 120 for implementing (e.g., configured and/or designed for) the systems and methods described herein. Optionally, any of the installation devices 116 could also be used as the storage device. Additionally, the operating system and the software can be run from a bootable medium, for example, a bootable CD.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, or a HDMI bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, manufactured by Google Inc; WINDOWS 7 and 8, manufactured by Microsoft Corporation of Redmond, Wash.; MAC OS, manufactured by Apple Computer of Cupertino, Calif.; WebOS, manufactured by Research In Motion (RIM); OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein. For example, the computer system 100 may comprise a device of the IPAD or IPOD family of devices manufactured by Apple Computer of Cupertino, Calif., a device of the PLAYSTATION family of devices manufactured by the Sony Corporation of Tokyo, Japan, a device of the NINTENDO/Wii family of devices manufactured by Nintendo Co., Ltd., of Kyoto, Japan, or an XBOX device manufactured by the Microsoft Corporation of Redmond, Wash.

In some embodiments, the computing device 100 may have different processors, operating systems, and input devices consistent with the device. For example, in one embodiment, the computing device 100 is a smart phone, mobile device, tablet or personal digital assistant. In still other embodiments, the computing device 100 is an Android-based mobile device, an iPhone smart phone manufactured by Apple Computer of Cupertino, Calif., or a Blackberry handheld or smart phone, such as the devices manufactured by Research In Motion Limited. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a tablet such as the Apple IPAD, or a digital audio player such as the Apple IPOD lines of devices, manufactured by Apple Computer of Cupertino, California. In another of these embodiments, the digital audio player may function as both a portable media player and as a mass storage device. In other embodiments, the computing device 100 is a digital audio player such as an MP3 players. In yet other embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4 MPEG-4 (H.264/MPEG-4 AVC) video file formats.

In some embodiments, the communications device 101 includes a combination of devices, such as a mobile phone combined with a digital audio player or portable media player. In one of these embodiments, the communications device 101 is a smartphone, for example, an iPhone manufactured by Apple Computer, or a Blackberry device, manufactured by Research In Motion Limited. In yet another embodiment, the communications device 101 is a laptop or desktop computer equipped with a web browser and a microphone and speaker system, such as a telephony headset. In these embodiments, the communications devices 101 are web-enabled and can receive and initiate phone calls.

In some embodiments, the status of one or more machines 101, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Generating a Three Dimensional (3D) Color Representation of an Object

Described herein are systems and methods for generating a three dimensional (3D) representation of an object. Illustrative applications for the present systems and methods may include, but are not limited to 3D color scanning of a person or object associated with medical treatment, health monitoring, physique and/or posture improvement and/or correction, fitting and/or design of garment or accessories, 3D modelling and 3D printing. Certain aspects of this disclosure are directed to a scanning booth or system for acquiring depth and color values from a person or an object, using a plurality of sensors spatially configured around the person or object. Each sensor may acquire depth and color information from a surface portion of the person or object. The configuration of sensors may be optimized and/or configured for imaging a human body or particular types of objects, e.g., by setting or adjusting a sensor's field of view, angle, orientation, and/or spatial arrangement with respect to one or more other sensors. The configuration of sensors can perform rapid scanning and 3D color image generation, for example within five seconds in certain embodiments. In some embodiments, fewer or only one sensor may be spatially moved and/or re-oriented with respect to the person/object to perform scanning, although the process may be prolonged (e.g., to 30 seconds).

Accurate co-registration of the color and depth values , e.g., during acquisition and processing of such information, can provide realistic or accurate generation of color images of surface portions of the person or object. A processor can locate and/or match overlapping 3D regions of the plurality of surface portions, for stitching into a 3D color model of the person or object. The processor may generate data for portions of the 3D model that may be missing, noisy or rejected. Certain embodiments of the present systems and methods may perform analysis on the generated or fully-constructed 3D color model, for example, performing measurement of body parts, determining tissue composition or body mass index (BMI), classifying body types, and comparing or tracking changes over time or over multiple 3D images. Secure and/or encrypted storage and transmission of an image can ensure privacy of an individual that has been scanned.

In various aspects, although this disclosure may sometimes refer to a person, or the scanning of a person in describing an operation or a system component, this is merely for illustration and not intended to be limiting in any way. Various objects, or types of objects (e.g., a mass, surface, body or volume of one or a combination of any type(s) of matter, composition or material) are contemplated, as are certain body parts and partial scanning of one or more objects, surfaces or bodies. As such, terms such as a “person”, “individual”, “user”, “body” or “object”, as hereafter referred to in this disclosure, may sometimes refer to any type of object, or a portion thereof. In some implementations, the object (e.g., matter or material) being scanned may not be visible in certain spectrum of light or electromagnetic wave, but can be detected via one or more other spectra and represented in appropriate or predetermined color(s). In yet other embodiments, the object may be scanned in alternative spectrum (e.g., infra-red, e.g., to acquire heat signatures that can be part of 3D color modeling). For example, certain heat signatures or hotspots on a human body can indicate certain afflictions that may require medical attention, and embodiments of the present systems may represent these by appropriate color(s).

In some embodiments, the sensor may acquire depth information but no color information. The system may generate a 3D image with the depth information, but the image may not appear as realistic and/or as effective (e.g., motivating) to a user as a 3D color image. Moreover, color information may be important or key in certain applications, such as identification of discoloration and/or hidden spots due to certain disease or affliction. Color information can help to distinguish between different issues, and/or indicate health. Certain discoloration may have a similar tone or brightness contrast to the skin and therefore can be overlooked even in a monochrome image. The system can provide a means to securely send a color scan of a patient's body or certain anatomy/injury, to a physician without requiring the patient to be physically present and inspected by the physician. The hassles of making an appointment, traveling to see the physician, and/or waiting to see a medical provider, can be avoided in certain situations through the use of the present solution.

With respect to some embodiments of the present systems and methods, a user may be directed to enter or be located (partially or entirely) within a scanning region or enclosure (e.g., a scanning booth). A space may be provided for the user to remove or change clothing. There may be audio (e.g., voice) and/or visual instruction to the user for the scanning process and/or preparation thereof. One or more types of user interfaces may be provided to the user, e.g., graphical user interface (GUI), voice-command interface, command-line interface, etc. For example, the user can use a touch screen interface to activate or initiate the scanning process. After, during or before initiating the scan process (e.g., by pushing a scan button), the user may stand on or move to a predetermined location in the scanning region (e.g., the center of the booth). In some embodiments, the system may provide a countdown of a predefined time duration, e.g., to allow the user to get prepared or get into a proper position, orientation and/or pose. During the scan, the users may have to remain still in a predetermined position, e.g., in a standing position with arms extended out to the side at a 15 degree angle away from their bodies. In some embodiments, support rails or other structure, or identified surfaces (e.g., for placing the user's palm) may assist the user to maintain a certain position and/or posture.

Responsive to the scanning, the system may generate an accurate and realistic 3D color image of the user, which can be rotated and/or tilted in any direction, and/or panned in/out for review and/or inspection. The 3D color image can allow the user to visualize certain areas of interest (e.g., a problem with posture, fat or cellulite areas, and/or muscular tone, size or definition). For example, areas which may not be easily inspected using mirrors and measuring devices, can be inspected (e.g., magnified or zoomed in, and/or re-oriented) using the 3D color image. In using the system, the user can sign into the user's existing account, register for a new account, or choose to be a one-time user without an account. For one-time users, in some embodiments, the system may not store the user's data and may delete the user's information after the user's use or review of the results (which may include a 3D color image, measurements and/or other report). For registered users, in some embodiments, the user can review the present data (e.g., measurements) and/or past or historical data collected over time. The user may be able to set or select one or more goals to reach, and a goal may be tracked by the system, e.g., against scanned results received over time. By way of illustration, the system may support one or more pre-configured goals, for example, for toning muscle(s), losing weight and/or improving posture(s). In some embodiments, the system can suggest or identify a program (e.g., exercise and/or diet) to a corresponding user responsive to a selected goal.

Referring to FIG. 2A, one embodiment of a system for constructing a three dimensional (3D) color representation of an object is depicted. The system may sometimes be referred to as a scanning booth, scanning cube, Perfetch Cube, or 3D color model generation and processing system. In brief overview, the system 211 may include one or more modules or subsystems (hereafter sometimes generally referred to as “modules”), for example, a plurality of sensors 220 and/or a 3D processor 290. The 3D processor may sometimes be generally referred to as a processor. Each of these modules may be controlled by, or incorporate features of a computing device, for example as described above in connection with FIGS. 1A-1C. Each module, and any sub-module thereof, may include hardware or a combination of hardware and software. For example, a module or submodule may include any application, program, library, script, task, service, process or any type and form of executable instructions executing on any type and form of hardware of the system. In some embodiments, a module or submodule may incorporate one or more processors and/or circuitries configured to perform any of the operations and functions described herein.

In some embodiments, the system 211 may include one or more sensors 200A-N designed, built and/or configured to measure, collect, capture and/or acquire depth and/or color information of a surface an object. A sensor 200 may incorporate one or more types of sensors or sensing elements. For example, the sensor may include one or more depth sensors 240A-N. In certain embodiments, the sensor 200 may include a depth sensor 140 and a color sensor. A depth sensor may include any type or form of range or proximity sensor or camera, e.g., that uses wave or sound reflection to estimate or measure a distance, range or depth (hereafter sometimes generally referred to as “depth”) of a surface. For example, the depth sensor may include an infrared laser projector.

The depth sensor may use any method to determine depth or distance to a specific point, for example but not limited to the use of structured light or a light pattern, time-of-flight, radar, sonar, interferometry, and a coded aperture pattern. The depth sensor may generate or produce an array or collection of values corresponding to some portion of the object, sometimes generally referred to as a depth image. For example, the depth image may comprise a plurality of data points or pixels (hereafter sometimes generally referred to as “pixels”). A pixel may include or be associated with a value representative of a depth or distance between the sensor and a corresponding point, feature or portion of the object. In some embodiments, the image may include a two-dimensional (2D) array of pixels, and a third dimension corresponding to depth values associated with the pixels. The depth image may be data-structured, configured and/or stored like a regular image, except that the values may be depth values rather than color, brightness and/or contrast values. By way of illustration, depth data may be represented as (x, y, depth) across an x-y grid in a depth image. The system may produce depth data as an image or frame for each depth sensor. Each pixel value of such an image may represent a distance between the sensor and a corresponding point or feature of the object.

In certain embodiments, the sensor may include one or more color or image sensors 250A-N. A color sensor 250 may include any type or form of color-sensitive sensor or camera. For example, a color sensor may incorporate one or more semiconductor charge-coupled devices (CCD) or active pixel sensors in complementary metal-oxide-semiconductor (CMOS) or N-type metal-oxide-semiconductor (NMOS, Live MOS) , or any hybrid (e.g., CCD/CMOS) technologies. The color sensor may include a light or electromagnetic sensor. In certain embodiments, the color sensor may be designed, built and/or configured to sense, detect, measure and/or represent one or more colors (e.g., based on the RGB color model). The color sensor may be designed, built and/or configured to derive color chromaticity and/or illuminance (or intensity) from any portion of an object or scene.

The color sensor may generate or produce an array or collection of values corresponding to some portion of the object, sometimes generally referred to as a color image. For example, the color image may comprise a plurality of pixels. A pixel may include or be associated with one or more values, for example, a pixel may be associated with a vector of values (e.g., RGB component intensities). Each value may be representative of a color or RGB intensity, grayscale brightness and/or contrast of a corresponding point, feature or portion of the object. By way of illustration, color data may be represented as (x, y, color) or (x, y, R, G, B) across an x-y grid in a color image. The system may produce color data as an image or frame for each color sensor. Each pixel value of such an image or frame may represent a configuration of one or more colors of a corresponding point or feature of the object.

In some embodiments, a depth sensor 220 and a color sensor 250 may be coupled or co-registered to acquire, provide, associate and/or store information that corresponds to a same or similar point, spot, feature or region on the object. By way of illustration, FIGS. 2B and 2C depict embodiments of process flows for generating a 3D color model of an object. For example, after an object is located within a scanning region, and a scan initiated on the object, the system may perform the scanning process by collecting data via the plurality of sensors. The data collected from a sensor may include depth data/image and color data/image. In FIG. 2C, for example, the system may generate a 3D point cloud based at least on the depth data/image determined from a surface portion of the object. The system may generate a plurality of 3D point clouds corresponding to the plurality of sensors or fields of view of the sensors.

Referring again to FIG. 2A, the system may include a processor 290 designed, built and/or configured to process images acquired by the plurality of sensors, into a 3D model or image. The processor may include one or more submodules, for example but not limited to a 3D processing module 230, a post-processing engine 270, a measurements engine 275, an image engine 260, and/or a posture classifier 265. For example, the 3D processing module may be designed, built and/or configured to produce a 3D point cloud. A 3D point cloud may comprise a plurality of points spatially distributed in three dimensions relative to each other and/or relative to a coordinate system. The 3D processing module may generate a 3D point cloud based on the depth data/image acquired by a sensor.

FIG. 2J depicts one illustrative embodiment of a flow diagram for generating a 3D color model of an object. In some embodiments, a plurality of point clouds are generated, which may undergo 3D model reconstruction as depicted in FIG. 2K, for example. For each sensor or field of view, the system (e.g., via the 3D processing module) may generate a 3D point cloud of a corresponding surface portion of the object. The system may locate and/or orient the 3D point cloud at a particular location with respect to a 3D space or coordinate system, based on one or more of a location of the sensor, a relative position of the sensor with respect to at least another sensor, and orientation of the sensor. For example and in one embodiment, the system may map the depth image to a spatial coordinate system in three dimensions that accommodates the spatial relationships between images generated by the plurality of sensors. In some embodiments, the system may generate a color 3D point cloud by mapping color data from the corresponding sensor or field of view. For example, the system may assign pixel-level color information to co-registered pixels in the depth image and/or points in the 3D point cloud.

The system may identify a co-registered pixel or point by matching pixel locations between a depth image and a color image acquired by the same sensor. For example, the depth sensor may generate a depth value that may be associated with at least one color value or pixel corresponding to a same point or feature of an object. In certain embodiments, the sensor 220 may generate an image (e.g., a single image) comprising depth and color information for at least some pixels of the image. The array of pixels in a depth and/or color image may be regularly spaced, or may be distributed more densely within a certain region in some embodiments. By way of non-limiting illustration, (x, y) intervals may be calibrated in the system before a (color and/or depth) image or frame is generated. For depth data, this may be described as regular intervals on a same depth. For different depths, the interval (or spatial) relationship may be restricted or altered by projective geometry, and may be described by perspective matrix. The system can generate an image at a resolution or granularity that is preconfigured, or selected from several different pre-defined or configurable resolutions for depth and/or color frames. The resolution of an image may affect the precision of the final 3D color model generated by the system. The sensor may be configured to acquire depth and/or color data of sufficient granularity, e.g., for generating natural-looking contours and/or colors in the 3D color image. The granularity or density of pixels of the acquired image(s) may be such that little or no interpolation may be needed.

The system may mesh or combine color 3D point clouds from different sensors together into a 3D color model of the object. The latter is sometimes referred to as meshing, 3D model construction, 3D model reconstruction or 3D model generation (hereafter sometimes generally referred to as model generation). For example, each sensor may produce data for generating a partial 3D models of the object. The partial 3D models may correspond to different sensor perspectives or field of views (e.g., top, bottom, front, back, sides), depending on the configuration of the sensors. The system may mesh data from multiple sensors based on reference points. For example, the system can cast the depth data from each sensor into a corresponding 3D point cloud. Two adjacent or proximate point clouds may have one or more overlapping regions. For example, the two sensors may be configured to have an overlapping field of view for acquiring depth and/or color data, e.g., to avoid missing data for 3D model generation.

FIG. 2K depicts one example embodiment of a flow diagram for performing 3D model generation or reconstruction. In certain embodiments, based on the physical position configuration of two sensors, the 3D processing module may determine and/or represent a relationship of the two corresponding point clouds in a transform matrix (or any other data structure), for example. By way of illustration, the 3D processing module can use the matrix to map, connect, link, orient and/or transform one point cloud to correspond to the other (e.g., in orientation and/or size), and may identify and/or approximately determine an overlapping region. The 3D processing module can use perspective geometry and/or iterative closest point processing to align two or more point clouds corresponding to two or more sensors.

The 3D processing module can identify one or more feature points between the point clouds corresponding to the overlapping area to find or identify matching feature points. The feature points may include structural features, e.g., corresponding to one or more points or pixels of a point cloud. The feature points may include one or more edges, vertices and/or faces (e.g., a facet or shape such as a triangle or any other type of polygon) obtained by connecting or linking two or more points of the 3D point cloud. Each feature point may include a configuration or arrangement of one or more points, edges, vertices and/or faces.

A feature point may include any shape, structure, gradient, slope, contour, curvature, characteristic or description of one or more points of a point cloud. In certain embodiments, a feature point may include color information, e.g., a color type (e.g., RGB color) and/or intensity corresponding to a point. A feature point may include a configuration, collection or arrangement of two or more points with specific color information, e.g., that can be matched between overlapping regions of at least two point clouds. The 3D processing module can combine, stitch, link, map, align, connect or integrate (hereafter sometimes generally referred to as “align”) two or more (or all) point clouds into a single (or third) point cloud based on the matching feature points. The 3D processing module can align or make alignment adjustment based on a minimization of alignment energy or disparity between two or more point clouds. For example, the system may perform a least means square calculation between one or more pairs of feature points from two point clouds. The least means square calculation may be based on structural (e.g., distance) and/or color values or measures. The 3D processing module can align two point cloud by reducing disparity or differences between a mapping of feature points.

In certain embodiments, the system may apply Poisson surface reconstruction or another algorithm/process to generate faces, vertices and/or edges for the single or third point cloud. A combination or collection of points, vertices, and/or faces may be referred to as a mesh (e.g., 3D mesh) or 3D model. In some embodiments, surface reconstruction may include vertices, edge and/or surface smoothing across at least a portion of the 3D model or mesh.

Referring again to FIGS. 2A, the processor may include a post-processing engine 270 that may be designed, built and/or configured for performing noise-reduction, smoothing, etc., on the 3D color model. FIGS. 2D and 2E depict example embodiments of flow diagrams for a method for performing post-processing on a 3D color model. In some embodiments, the 3D color model may be referred to as a 3D colored (human body or object) mesh, e.g., an output of the scanning process 201, and input to the 3D color model post-processing process 202. The 3D color model post-processing process may generate a 3D model from which measurements (e.g., of the human body) can be more accurately performed. The post-processing process may include one or more operations, for example but not limited to morphological processing, geometric partial differential equation (PDE) image processing, and color information correction and interpolation.

In some embodiments, morphological processing comprises a process to reduce, suppress or eliminate one or more mesh components that do not correspond to, or is not consistent with the object (e.g., which are not intended to be, or does not appear to be part of the human body mesh). In certain embodiments, geometric PDE image processing on the 3D colored mesh may reduce noise. Geometric PDE image processing may perform noise reduction without sacrificing too many details (e.g., through adaptive processing). Geometric PDE image processing may smooth the 3D colored mesh (e.g., as a result of, or a concurrent effect of noise reduction). Geometric PDE image processing may fill holes or missing sections in the 3D colored mesh. For example, geometric PDE image processing may perform estimation, extrapolation and/or projections of a missing section, e.g., using surrounding depth and/or color information.

The post-processing engine may perform smoothing and/or noise reduction or elimination via other means or methods. Smoothing may be performed on color features and structural features such as contours. The post-processing engine may perform noise processing, which may include identification of isolated point(s), such as those that appear to be disconnected from or unassociated with surrounding or nearby points. One type of noise may include an unnatural and/or sharp change of edges and/or surfaces on a 3D image/model of a human body or object. This noise may be caused by error depth pixels or systematic error (e.g., dirt on the sensor, faulty sensor pixel). The post-processing engine may perform noise processing and/or smoothing to reduce or remove noise, artifacts and other irregularities.

In some embodiments, color information in the 3D colored mesh might include artifacts, e.g., caused by uneven illumination, etc. In addition, color information in the mesh may be completely lost where a missing segment occurs in the mesh. The post-processing module may perform geometric PDE image processing or extrapolation to fill missing portions of the mesh but such processing may not generate the color information. Color information correction and interpolation can provide, project, extrapolate or estimate corrected or missing color information to address artifacts or missing data. The process can identify a location in the mesh having wrong and/or missing color information. The process can infer the incorrect or missing color information based on surrounding and/or nearby color information.

In some embodiments, for example as depicted in FIG. 2E, the model post-processing may include model or mesh compression. The compression may reduce and/or simplify mesh data for transmission and/or storage. The output of the model post-processing may be referred to as a processed 3D colored (human body or object) mesh, processed mesh, or processed model (hereafter sometimes generally referred to as a processed mesh or 3D color image). The processed mesh may be input to a process, sometimes referred to as (body or object) parts and shape identification 203 process, for example as depicted in FIG. 2A. In some embodiments, the processed 3D color model or mesh may comprise a collection of values in a data structure, e.g., (x,y,z, color) coordinate values across a x-y-z grid. The (x,y,z) points may be closely spaced or approximately regularly spaced. In some embodiments, the casting from depth data to point cloud(s) may cause some amount of irregularity in the spatial distribution of the points. Post-processing may fill in some of the missing points or supplement sparsely-distributed points. In various embodiments, any of the operations or process described herein may be combined, or its sequence relative to others modified from any of the illustrative embodiments

FIG. 2F depicts an embodiment of a block diagram of a system for generating a 3D color image and performing parts and/or shape identification. In some embodiments, a data generation phase or stage comprises the generation of a 3D color image or model. The system may further perform measurements, for example, of weight, height, conductivity, etc., of the object or person. The system may incorporate or use information from one or more third-parties, for example, information about population distribution associated with body types, weight, height, expected weight loss or muscle mass increase based on particular exercise and/or dietary programs, types of measurements for tracking specific types of progress, etc. In some embodiments, the system may perform (body or object) parts and/or parts identification.

In certain aspects, a measurements engine 275 may be designed, built and/or configured to perform parts and/or shape identification. FIG. 2G depicts an illustrative embodiment of a flow diagram for performing parts and/or shape identification. Based on the 3D color model, the measurements engine may determine or identify the location and/or boundaries of various object parts or body anatomy. By way of illustration, based on a 3D color model of a body, the measurements engine may identify or locate the armpits and/or crotch regions or points. The measurements engine may identify or locate points or regions where limbs connect to the torso. The measurements engine may identify or locate certain pulse points and/or ankle points. The measurements engine may identify any of these to be separation or boundary points for segmenting, distinguishing or demarcating features such as the arms, head, legs and torso, for example. The measurements engine may scan or analyze the 3D model's various perspectives, e.g., front and sides, to generate 2D images. The measurements engine may analyze the 2D images for determining the heights of various anatomy or features. Based at least in part on the heights, the measurements engine may confirm, determine or identify the location and/or extent of each anatomy or feature.

The measurements engine may perform measurements on the 3D model. In some embodiments, the measurements engine acquire samples or representative points (e.g., from the processed 3D model, mesh or point cloud) for each target anatomy or feature of the 3D model. The measurements engine may perform noise reduction or elimination on the acquired samples or points. The measurements engine may perform a virtual measurement of a target feature or anatomy, e.g., by simulating a measuring tape around a torso or arm region. The measurements engine may, in certain embodiments, perform measurement on the processed 3D model, instead of sampled data. In some embodiments, the measurements engine may digitally remove certain parts of the 3D model (e.g., a chest region) to perform certain measurements (e.g., around an upper arm).

FIG. 2H depicts one illustrative embodiment of a flow diagram of operations performed by a measurement engine. Based on the acquired samples or representative points, the measurements engine may generate or extract contours of the samples, e.g., between sample points, along a line and/or along a surface targeted for measurement. The measurements engine may collect and/or connect a plurality of contours for the measurement. The measurements engine may perform measurement or distance estimation on each contour or segment (e.g., between two sample points), and may sum up the measurements over the collection or plurality of contours (e.g., tracing a circumference of a thigh or torso), to produce a single measurement (e.g., of the thigh or torso).

In some embodiments, the processor includes an image engine 260 configured to generate and/or display images based on the 3D color model. FIG. 21 depicts one example embodiment of operations performed by an image engine. The image engine may identify points or samples from the processed 3D color model based on a selected or preconfigured view. For example, the user may provide instructions to the system, via the interface, to display a rear view of the 3D color model. The image engine may identify points from the 3D color model for constructing the view (e.g., in 2D or stereoscopic format). The image engine may generate an outline of one or more features or anatomy identified for the desired view. The image engine may determine or generate texture (e.g., realistic texture of skin, wrinkles, muscle striations) for filling a surface of each outlined feature, e.g., based on color information and/or depth/3D information from the 3D color model. The image engine may generate the desired view in a 2D display or a suitable 3D format.

In some embodiments, the processor includes a posture classifier designed, built and/or configured to match a posture from the 3D color model to one or more of a plurality of types of postures. For example, based on an outline or contour of specific body parts according to the 3D model, and/or measurements from the measurements engine, the posture classifier may relate or identify a posture type and/or a potential posture issue, to the corresponding person or user. The system can track or monitor posture changes over time (e.g., over multiple scans). The posture classifier may flag out potential (e.g., medical-related) problems, and may provide recommendations for posture improvement. The posture classifier may in some embodiments guide a user (e.g., interactively, over two or more 3D scans) in posture correction.

Other types of knowledge discovery may be performed by the system. For example, and referring again to FIG. 2F, historical data of a user may be stored and retrieved for tracking and/or comparison with new data. The system may generate a health report for a user based on analysis on a 3D color model of the person, with or without historical data. The system may project or predict progress or changes to a user's health or body based on several sets of data obtained over time. In some embodiments, the system may evaluate an effectiveness of a program or training regiment, based on a person's goals, medical needs, expected progress, etc., and/or relative to another person's progress or that of a sample population.

FIG. 2L depicts one illustrative embodiment of a block diagram of a system for generating and accessing a 3D color image of an object. The system may include an in-booth application for generating and/or collecting information such as model data, measurements, analysis reports, recommendations, third-party information, and/or user information. Accordingly, data transferred between the application server and client(s) (e.g., in-booth application, web, app) are not limited to 3D model and measurement data. The application server may securely receive the data from the in-booth application, intended for storage and/or transmission to a remote site (e.g., to a physician's terminal, or a user's computing device). The application server securely communicate the received data to one or more file servers (e.g., distributed storage or cloud-based storage), from which the data may be subsequently requested and/or retrieved.

The application server may retrieve or access stored data, e.g., responsive to receiving a request for the data by an authorized person. The authorized person may request for access via the system (e.g., scanning booth) or a computing device. For example, the authorized person may access the data via an app or application installed on the person's computer or mobile device, and the data may be securely communicated over the web or a network. Referring again to FIG. 2F, an authorized person can access or visualize the data using a number of interfaces, such as but not limited to a web interface, an installed app, or via text (e.g., SMS) or email.

FIG. 2M depicts one example embodiment of a flow diagram of a method for generating and processing a 3D color model of an object. Various aspects have been discussed above in connection with at least FIGS. 2A-2K. In certain embodiments, the measurements engine may generate one or more tags for the 3D color model, for example, tags for identifying and/or providing information and/or measurements of particular features or anatomy. The measurement engine may provide or generate 2D views or snapshots of body parts or features, e.g., based on one or more pre-configured or selected views. These views may be presented to the user via an interface or a display of the system. In some embodiments, one or more views may be remotely accessed by a user from a web server or other online/cloud service.

Referring now to FIG. 2N, one embodiment of a method for constructing a three dimensional (3D) color representation of an object is depicted. A first sensor may acquire a first depth image and a first color image of an object from a first angle relative to the object (301). A second sensor configured to acquire a second depth image and a second color image of the object from a second angle relative to the object (303). A processor may map color information from pixels of the first color image to pixels of the first depth image to form a first 3D distribution of colored points representing a first surface portion of the object (305). The processor may map color information from pixels of the second color image to pixels of the second depth image to form a second 3D distribution of colored points representing a second surface portion of the object (307). The processor may match, based on 3D structure, a portion of the first 3D distribution of colored points, to a portion of the second 3D distribution of colored points (309).

Referring now to (301), and in some embodiments, a first sensor may acquire a first depth image and a first color image of an object from a first angle relative to the object. The sensor may be a component of a system 211, e.g., embodiments of which is described above in connection with at least FIG. 2A. The sensor may acquire the depth and color images/data from a first perspective, orientation or field of view, relative to the object and/or relative to at least another sensor. The sensor may acquire the first depth image, the first depth image comprising an array of collection of depth values, for example, as described above in connection with at least FIG. 2A. In certain embodiments, each pixel or data point of the first depth image may include or have a value representing a spatial distance of the object relative to the first sensor.

The sensor may acquire the first color image, the first color image having a resolution that is at least the same as that of the first depth image. For example, the color image may have at least as many data points or pixels as the depth image. The sensor may acquire the first color image, the first color image comprising an array of collection of color values or vectors, for example, as described above in connection with at least FIG. 2A. The sensor may acquire a color image that is co-registered accurately or precisely with the depth image. For example, pixels or data points of the depth and color images may map to a same coordinate system or spatial interval. The first sensor may acquire the first depth image via a first depth sensor of the first sensor, and may acquire the first color image via a first color sensor of the first sensor. The depth and color sensors may be positioned in close proximity and oriented consistently with respect to the object. The depth and color images may be acquired simultaneously or substantially simultaneously, e.g., to ensure accurate registration between the depth and color images. For example, the user may move during the image acquisitions, potentially causing disparity between the depth and color images if the depth and color sensors are not substantially synchronized.

Referring now to (303), and in some embodiments, a second sensor is configured to acquire a second depth image and a second color image of the object from a second angle relative to the object. The operations herein are substantially the same as embodiments of operations described above in connection with (301). In some embodiments, the second sensor acquires the second depth image and second color image from an angle, perspective, orientation or field of view that is different from and/or coordinated with the first sensor. The second sensor may acquire the second depth image and second color image from an angle, perspective, orientation or field of view that abut, or overlap in part with the first depth image and the first color image. The second sensor may acquire the second depth image and second color image simultaneously or substantially simultaneously, with respect to the first depth image and first color image, e.g., to ensure accurate registration between the first set of images and the second set of images. For example, the user may move during the two sets of image acquisitions, potentially causing disparity between the two sets of image if the first and second sensors are not substantially synchronized.

In some implementations, e.g., where 3D image generation time may not be critical, and/or where the object may be substantially stationary, the first sensor and the second sensor can be the same sensor. For example, the sensor may acquire the first set of images from a first angle, and move to another angle to acquire the second set of images.

Referring now to (305), and in some embodiments, a processor of the system may map color information from pixels of the first color image to pixels of the first depth image to form a first 3D distribution of colored points representing a first surface portion of the object. A 3D processing module of the processor may map, combine or integrate the color information to pixels of the depth image. The 3D processing module of the processor may combine the color image to the depth image, for example, by generating a single image with pixels that include or have color and depth information. In some embodiments, 3D processing module performs depth refinement and/or correction prior to combining the color information. The 3D processing module may perform noise reduction, artifact removal and/or smoothing on the depth image/data, for example. In some embodiments, the 3D processing module may perform similar refinement and/or correction to the color image/data, while in other embodiments, the color data is maintained.

In some embodiments, the 3D processing module generates a 3D point cloud based on the depth image. For example, the 3D processing module may map or translate the pixel locations to two axes of a coordinate system, and corresponding depth values to a third axes of the coordinate system. In certain embodiments, the color information is combined with the depth image before generating a 3D point cloud corresponding to the first sensor.

To combine color and depth information, the 3D processing module may identify a co-registered pixel or point by matching pixel locations between a depth image and a color image acquired by the same sensor. The 3D processing module may assign pixel-level color information to co-registered pixels in the depth image and/or points in the 3D point cloud. The 3D processing module may identify a pixel with a depth value that corresponds with at least one pixel from the color image, e.g., corresponding to a same point or feature of the object. For example and in some embodiments, since the color image has a resolution that is at least the same as that of the depth image, the 3D processing module may map one or more color pixels to a corresponding pixel of the depth image. The 3D processing module may perform averaging (e.g., mean, median or weighted averaging) on the one or more color pixels, to map a resulting color to the corresponding pixel of the depth image. In some embodiments, the sensor may generate an image (e.g., a single image) comprising depth and color information for each pixel of the image.

The 3D processing module may generate or form a first 3D distribution of colored points (sometimes generally referred to as a 3D point cloud) representing a first surface portion of the object. The 3D processing module may generate or form the first 3D distribution of colored points corresponding to a first angle, perspective and/or field of view relative to the object. The 3D processing module may locate and/or orient the first 3D point cloud at a particular location with respect to a 3D space or coordinate system, for example based on one or more of a location of the sensor, a relative position of the sensor with respect to at least another sensor, and an orientation of the sensor. For example and in one embodiment, the system may map the depth image to a spatial coordinate system in three dimensions that accommodates the spatial relationships between images generated by the plurality of sensors.

Referring now to (307), and in some embodiments, the processor may map color information from pixels of the second color image to pixels of the second depth image to form a second 3D distribution of colored points representing a second surface portion of the object. The operations herein are substantially the same as embodiments of operations described above in connection with (305). In some embodiments, the 3D processing module may form the second 3D distribution of colored points, or second 3D point cloud independent of the first 3D point cloud. The 3D processing module may (e.g., approximately) orient and/or position the second 3D point cloud relative the first 3D point cloud. For example, the 3D processing module may calculate or determine a transformation (e.g., linear translation, rotation, tilt, resizing) of one 3D point cloud relative to at least another 3D point cloud. The 3D processing module may calculate, estimate or determine the transformation based on the relative position, orientation, field of view, distance of each sensor with respect to the object, etc. The 3D processing module may map or approximately map the second 3D point cloud to the same 3D spatial coordinate system as the first 3D point cloud. In some embodiments, the mapping to the same coordinate system may be approximate, and may require further alignment. In certain embodiments, alignment is performed without mapping the two 3D point clouds to the same coordinate system.

Referring now to (309), and in some embodiments, the processor may match, based on 3D structure, a portion of the first 3D distribution of colored points, to a portion of the second 3D distribution of colored points. The 3D processing module may correlate or otherwise match a portion of the first 3D point cloud, to a portion of the second 3D point cloud. The 3D processing module may align the first 3D point cloud to the second 3D point cloud based on the matching. The 3D processing module may mesh or combine color 3D point clouds from different sensors together into a 3D color model of the object. The system may mesh 3D point clouds or data from multiple sensors based on reference points. For example, two adjacent or proximate point clouds may have one or more overlapping regions because the corresponding sensors may have overlapping field of views.

In certain embodiments, based on the physical arrangement or configuration of two sensors relative to each other and/or relative to the object, the 3D processing module may determine and/or represent a relationship of the two corresponding point clouds in a transform matrix (or any other data structure), for example. This process and/or transformation may be similar to, or the same as certain operations described above in connection with (307). In some embodiments, the transformation and/or related operations may be performed in (307) and/or (309). By way of illustration, the 3D processing module can use the matrix to map, connect, link, orient and/or transform one point cloud to correspond to the other (e.g., in orientation and/or size), and may identify and/or approximately determine an overlapping region. The 3D processing module can use perspective geometry and/or iterative closest point processing to align two or more point clouds corresponding to two or more sensors.

The 3D processing module can identify one or more feature points between the point clouds corresponding to the overlapping area to find or identify matching feature points. The feature points may include structural features, e.g., corresponding to one or more points or pixels of a point cloud, edges, vertices and/or faces, for example as described above in connection with at least FIGS. 2A and 2K. In certain embodiments, a feature point may include color information, e.g., a color type (e.g., RGB color) and/or intensity corresponding to a point, for example as described above in connection with at least FIGS. 2A and 2K. The 3D processing module can combine, stitch, link, map, align, connect or integrate two or more (or all) 3D color point clouds into a single (or third) 3D color point cloud based on the matching feature points.

In some embodiments, the 3D processing module may perform alignment based on a minimization or reduction of alignment energy between the first 3D point cloud and the second 3D point cloud (e.g., with respect to any other 3D point clouds). The 3D processing module can align or adjustment for align based on a minimization of alignment energy or disparity between two or more point clouds. For example, the 3D processing module may perform a least means square calculation between one or more pairs of feature points from two point clouds. The least means square calculation may be based on structural (e.g., distance) and/or color values or measures. The 3D processing module can align two point cloud by reducing disparity or differences between a mapping of feature points. The 3D processing module can form or generate a 3D representation of a surface of the object by aligning between the first 3D point cloud, the second 3D point cloud. The 3D processing module can form or generate the 3D representation by aligning between the first and second 3D color point clouds, and at least one other 3D point cloud obtained based on the same object.

In some embodiments, the system may perform post-processing on the 3D representation. For example, a post-processing engine may perform geometric partial differential equation (PDE) based filtering on the 3D representation to generate at least one point that is missing from the 3D representation. The system may calculate color information for the at least one point that is missing from the 3D representation. Aspects of these and other processing are described above in connection with at least FIGS. 2A, 2D and 2E.

It should be noted that certain passages of this disclosure can reference terms such as “first” and “second” in connection with images, sensors, 3D distribution of colored points, etc., for purposes of identifying or differentiating one from another or from others. These terms are not intended to merely relate entities (e.g., a first sensor and a second sensor) temporally or according to a sequence, although in some cases, these entities can include such a relationship. Nor do these terms limit the number of possible entities (e.g., sensors) that can operate within a system or environment.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A method for constructing a three dimensional (3D) color representation of an object, comprising:
(a) acquiring, by a first sensor, a first depth image and a first color image of an object from a first angle relative to the object;
(b) acquiring, by a second sensor, a second depth image and a second color image of the object from a second angle relative to the object;
(c) mapping color information from pixels of the first color image to pixels of the first depth image to form a first 3D distribution of colored points representing a first surface portion of the object;
(d) mapping color information from pixels of the second color image to pixels of the second depth image to form a second 3D distribution of colored points representing a second surface portion of the object; and
(e) matching, based on 3D structure, a portion of the first 3D distribution of colored points, to a portion of the second 3D distribution of colored points.

2. The method of claim 1, wherein (a) comprises acquiring the first depth image, the first depth image comprising an array of depth values.

3. The method of claim 1, wherein (a) comprises acquiring the first color image, the first color image having a resolution that is at least the same as that of the first depth image.

4. The method of claim 1, wherein (a) comprises acquiring the first depth image, each pixel of the first depth image having a pixel value representing a spatial distance of the object relative to the first sensor.

5. The method of claim 1, wherein (a) comprises acquiring the first depth image via a first depth sensor of the first sensor, and acquiring the first color image via a first color sensor of the first sensor.

6. The method of claim 1, wherein (e) comprises minimizing an alignment energy between the first 3D distribution of colored points and the second 3D distribution of colored points.

7. The method of claim 1, further comprising aligning the first 3D distribution of colored points to the second 3D distribution of colored points based on the matching.

8. The method of claim 1, further comprising forming a 3D representation of a surface of the object by aligning between the first 3D distribution of colored points, the second 3D distribution of colored points, and at least one other 3D distribution of colored points.

9. The method of claim 8, further comprising performing geometric partial differential equation (PDE) based filtering on the 3D representation to generate at least one point that is missing from the 3D representation.

10. The method of claim 9, further comprising calculating color information for the at least one point that is missing from the 3D representation.

11. A system for constructing a three dimensional (3D) color representation of an object, the system comprising:
a first sensor configured to acquire a first depth image and a first color image of an object from a first angle relative to the object;
a second sensor configured to acquire a second depth image and a second color image of the object from a second angle relative to the object; and
a processor configured to:
map color information from pixels of the first color image to pixels of the first depth image to form a first 3D distribution of colored points representing a first surface portion of the object,
map color information from pixels of the second color image to pixels of the second depth image to form a second 3D distribution of colored points representing a second surface portion of the object, and
match, based on 3D structure, a portion of the first 3D distribution of colored points, to a portion of the second 3D distribution of colored points.

12. The system of claim 11, wherein the first sensor is configured to acquire the first depth image, the first depth image comprising an array of depth values.

13. The system of claim 11, wherein the first sensor is configured to acquire the first color image, the first color image having a resolution that is at least the same as that of the first depth image.

14. The system of claim 11, wherein the first sensor is configured to acquire the first depth image, each pixel of the first depth image having a pixel value representing a spatial distance of the object relative to the first sensor.

15. The system of claim 11, wherein the first sensor comprises a first depth sensor and a first color sensor.

16. The system of claim 11, wherein the processor is configured to minimize an alignment energy between the first 3D distribution of colored points and the second 3D distribution of colored points.

17. The system of claim 11, wherein the processor is configured to align the first 3D distribution of colored points to the second 3D distribution of colored points based on the matching.

18. The system of claim 11, wherein the processor is configured to form a 3D representation of a surface of the object by aligning between the first 3D distribution of colored points, the second 3D distribution of colored points, and at least one other 3D distribution of colored points.

19. The system of claim 18, wherein the processor is configured to perform geometric partial differential equation (PDE) based filtering on the 3D representation to generate at least one point that is missing from the 3D representation.

20. The system of claim 19, wherein the processor is configured to calculate color information for the at least one point that is missing from the 3D representation.
